(19) United States
(12) Patent Application Publication
(10) Pub. No.: US 2020/0325736 A1
(43) Pub. Date: Oct. 15, 2020

(54) THREADED CONNECTION

(71) Applicant: Crystin Manufacturing Company, Inc., Odessa, TX (US)

(72) Inventor: Justin Hackleman, Odessa, TX (US)

(21) Appl. No.: 16/843,996

(22) Filed: Apr. 9, 2020

Related U.S. Application Data
(60) Provisional application No. 62/831,228, filed on Apr. 9, 2019.

(51) Int. Cl. E21B 17/042; F16L 15/00; F16L 15/06

(52) U.S. Cl. CPC E21B 17/0426; F16L 15/06; F16L 15/006

(57) ABSTRACT

Disclosed is a tool joint connection comprising a pin having a body and a helically extending external pin thread and box having a body and a helically extending internal box thread. The external pin thread and internal box thread are configured for connection with each other such that when connected the pin body and the box body are aligned longitudinally. The box thread has a box base in contact with the box body and the pin thread having a pin base in contact with the pin body and the pin base is wider than said box base. In a preferred embodiment, the area wherein the box base is in contact with the box body defines the box contact area and the area wherein the pin base is in contact with the pin body defines the pin contact area and the pin contact area and said box contact area are generally the same.

### CROSS REFERENCE TO PRIOR APPLICATIONS

The present application claims priority under the Paris Convention to U.S. Application No. 62/831,228, filed Apr. 9, 2019. The entire contents of such prior application is incorporated herein by reference.

### FIELD OF THE DESCRIPTION

The invention relates to a general means for releasably securing a pair of connection members. In particular, the invention relates to a threaded connection for use in high torque applications.

### BACKGROUND

Threaded connections are one of the oldest and most common way of coupling two components, commonly called a pin component and a box component. The applications are many, but common applications include but are not limited to, a nut and bolt connection, threaded pipe connections, collared threaded connections, and threaded rods. Designs of threaded connections vary greatly depending on the application. One common issue in many applications, particularly high torque applications, is that the threads of the pin component are subject to high shear forces and failure of the treads is common. This requires the pin components to be monitored and replaced, typically on a regular basis.

One example of a high-torque threaded connection is found in oil field applications. Interlocking threaded connections are commonly used to couple adjacent tubular members in a drill string. In general, the connections comprise a male pin member designed to mate within a female box member. When in use, these tubulars are subject to various stresses including tensile, compressive, shear, and bending loads which result in fatigue and ultimate failure of the threaded connection. Failure is often by way of thread rupture, particularly in the pin thread which takes a larger portion of the stresses compared to the box thread.

The prior art has identified different geometries to strengthen the threads to reduce damage and improve durability and increase the life of the tubular. For example, U.S. Pat. No. 6,030,004 provides a tool joint for a drill pipe having double, inter-engaging shoulders and tapered high strength threads that are designed to provide the box and pin connection with increased bending strength ratio and torque resistance as well as improved shear strength when compared to a traditional thread. The tool joint includes tapered threads having equal angle thread flanks which results in threads having a thicker base and being able to tolerate higher torque as compared to conventional threads. The threads are designed with a large root radius to decrease stress concentration and with smaller radii of intersection with adjacent thread flank surfaces to efficiently resist torque and to minimize stress and to provide for enhanced shear strength. Designs which require complex thread geometries are difficult and/or expensive to manufacture.

Other designs focus on altering the shoulder design of the pin and box to take more forces and thus reduce the frequency of failure of the threads. An example of such a design is found in U.S. Pat. No. 5,908,212. This patent discloses a double shoulder connection designed to withstand increased torque and maintain high torsional strength. In particular, the Patent is directed to maximizing the torsional strength of a threaded connection by correlating a transverse cross-sectional counterbore area of the box and a transverse cross-sectional nose area of the pin. Again, the more complex geometry of the pin and box in such designs can increase costs related to manufacturing.

The prior art fails to disclose a simple, cost effective thread design which to distribute the shear forces between the pin treads and the box in a generally even manner.

### SUMMARY OF THE DESCRIPTION

Disclosed is a threaded connection comprising a pin having a body and a helically extending external pin thread and box having a body and a helically extending internal box thread. The external pin thread and internal box thread are configured for connection with each other such that when connected the pin body and the box body are aligned longitudinally. The box thread has a box base in contact with the box body and the pin thread having a pin base in contact with the pin body and the pin base is wider than said box base.

In a preferred embodiment, the area wherein the box base is in contact with the box body defines the box contact area and the area wherein the pin base is in contact with the pin body defines the pin contact area and the pin contact area and said box contact area are generally the same.

Further disclosed is a drill string tubular comprising an elongate hollow body having a first end and a second end with a pin extending from the first end and a box extending from the second end. The pin has a body and a helically extending external pin thread while the box has a body and a helically extending internal box thread. The external pin thread of a first tubular is configured for connection to an internal box thread of a second tubular such that when connected the first tubular and the second tubular are aligned longitudinally. The box thread has a box base in contact with the box body and the pin thread has a pin base in contact with the pin body and the pin base is wider than the box base.

In a preferred embodiment, the area wherein the box base is in contact with the box body defines the box contact area and the area wherein the pin base is in contact with the pin body defines the pin contact area and the pin contact area and the box contact area are generally the same

### BRIEF DESCRIPTION OF THE FIGURES

The features of certain embodiments will become more apparent in the following detailed description in which reference is made to the appended figures wherein:

FIG. 1 is a partial cross-sectional view of the tool joint connection;

FIG. 2 is a perspective view of traditional threads shown in isolation;

FIG. 3 is a partial cross-sectional view of a traditional the tool joint connection showing the stress distribution when the tool joint connection is under load;

FIG. 4 is a depiction of the stress distribution of a thread of the connection;

FIG. 5 is a perspective view of a preferred embodiment of the thread design of the current invention shown in isolation;

FIG. 6 is a partial cross-sectional view of the tool joint connection of a preferred embodiment of the thread design showing the stress distribution when the tool joint connection is under load;

FIG. 7 shows the stress distributions of the tool joint connection of the present invention compared to a tradition thread; and

FIG. 8 is a partial cross sectional view comparing the thread design of the current invention to traditional thread designs.

FIG. 9 is a schematic of an oil rig and drill string assembly;

FIG. 10 is a side view of a tubular;

### DETAILED DESCRIPTION

There are many different types of threaded connections however, all are comprised of a pin body configured to fit into and releasably engage a box body. Examples of such connections include but are not limited to, a nut (pin body) and bolt (box body), threaded pipes and connectors, threaded rods and connectors and threaded tubes and connectors.

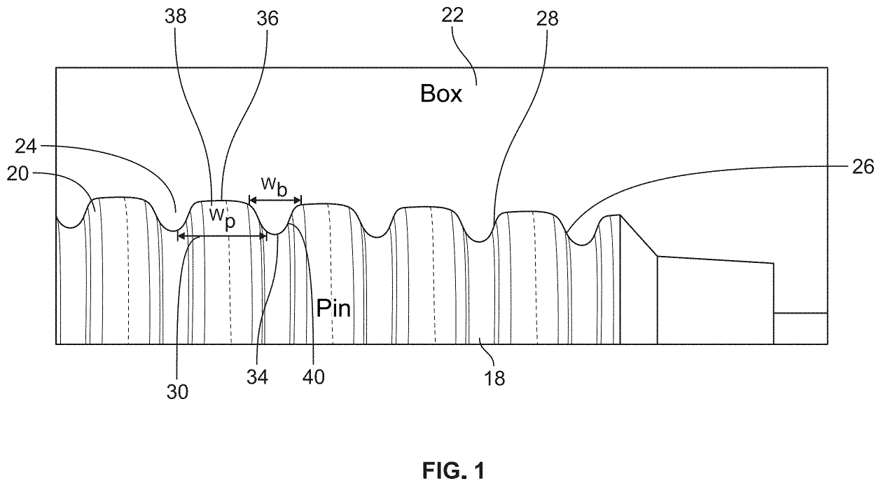

FIG. 1 shows the threaded connection of a pin and a box of one embodiment of the present invention. The connection comprises a pin body 18 having a helically extending external pin thread 20 and a box body 22 having a helically extending internally box thread 24. The helically extending external pin thread 20 is configured to engage and mate with the helically extending internal box thread 24.

As used herein and shown in FIG. 1, the term leading flank 26 of the pin 14 is intended to designate the flank of the pin which first engages during the connection with the box thread 24. The trailing flank 28 of the pin 14 is intended to designate the flank of the pin furthest from the end thereof. Each the pin thread 20 and the box thread 24 have a base, 30 and 32 respectively, which is the portion of the thread which is in contact with and connected to or integral with the body of the pin or box respectively. Each of the pin base 30 and box base 32 have widths, wₚ and w_{b} respectively. The term root is intended to designate the transition portion of the tread between the leading flank and the trailing flank. The pin root is designated by reference character 34, while the box root is designated by reference character 36. The term crest of the pin 38 is located between the adjacent flanks and is configured to fit between adjacent flanks of the box thread 24. It follows that the box crest 40 is located between adjacent box flanks and is configured to fit between adjacent flanks of the pin thread 20.

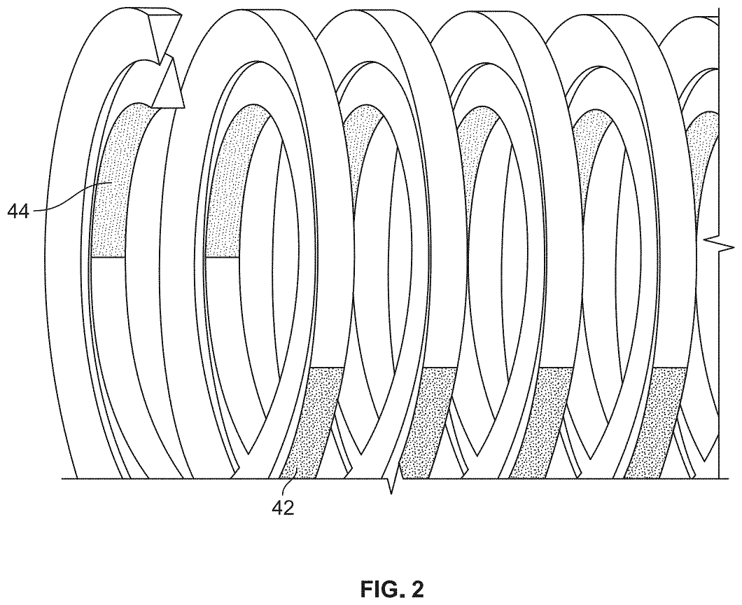

Conventional threads on pin and box ends are typically designed such that the pin thread and the corresponding box thread are the same or very similar in size and shape. Since, the external pin thread must fit inside and inter-engage with the internal box thread, it follows that the outer diameter of the pin is smaller than the internal diameter of the box. Consequently, the pin thread has a smaller contact area with the pin body than the contact area of the box thread with the box body. As a result, the pin thread is subjected to more concentrated shear stresses compared to the box thread. This is depicted in FIG. 2 wherein the contact area 42 between the box body and the base of the box thread is shown in cross hatching and the contact area 44 between the pin body and the base of the pin thread is shown in hatching.

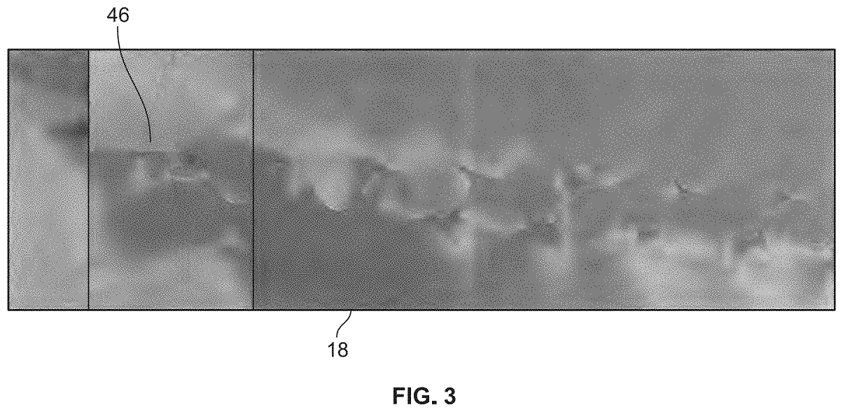

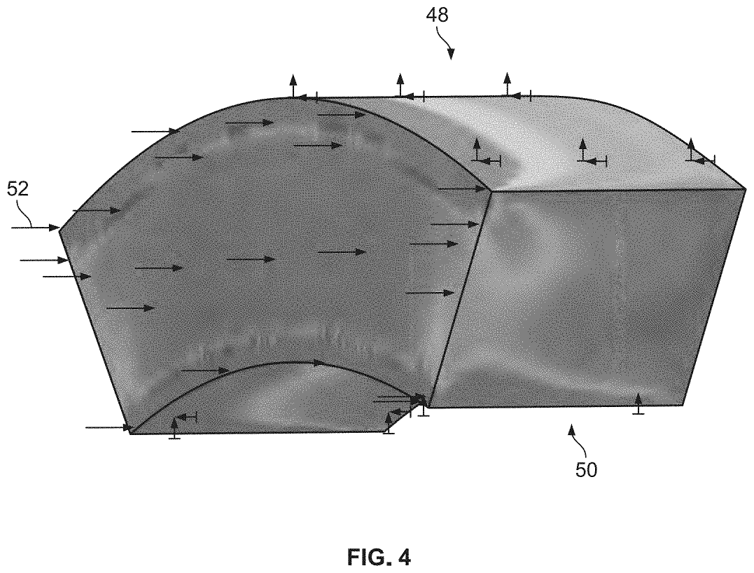

This difference in contact area between the pin thread and the box thread increases the likelihood of wear or failure of the pin threads. The resulting stress profile can be seen in FIG. 3, which shows a high stress concentration, shown in darker shading, in the pin threads 20 close the shoulder 46 of the pin 14. This area of high stress is present throughout the interior of the pin body 18 and continues down a substantial length of the pin. Furthermore, the stress is concentrated mostly in the pin, with much lower stress concentrations in the box. Such high pin stress concentrations results in the shearing or rupture of the pin thread and increases fatigue of the pin body. This is further illustrated in FIG. 4 which illustrates shear stress on the box thread in the top region 48 and shear stress on the pin thread in the bottom region 50. The arrows 52 represent the shear stress. As shown, stress is distributed on box thread due to increased contact area between the base of the box thread and the box body when compared to the contact area between the base of the pin thread and the pin body. Thus, it follows that increasing the contact area of the base of the pin thread to the pin body, the stress would be similarly distributed through the pin thread as it is the box thread.

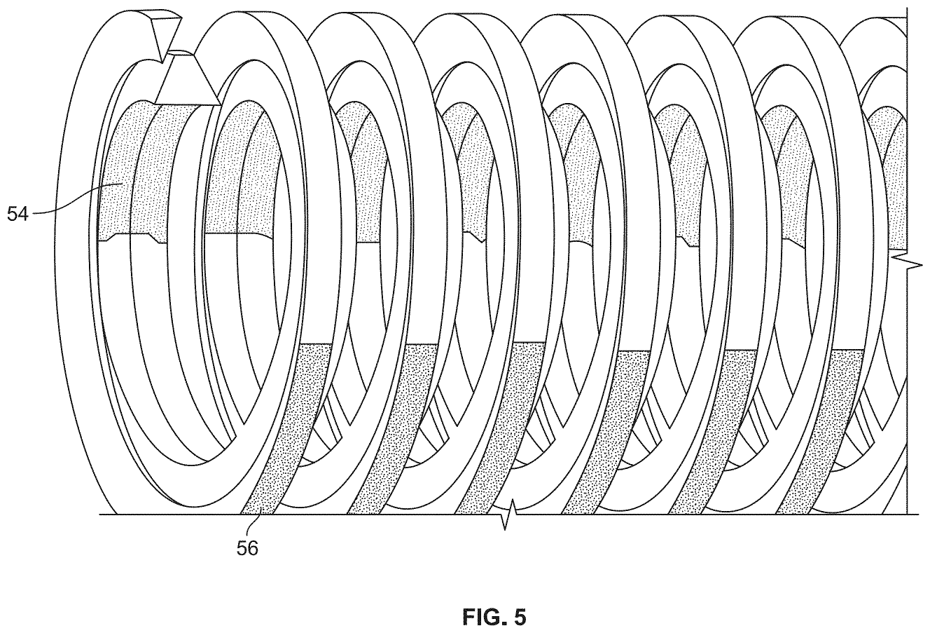

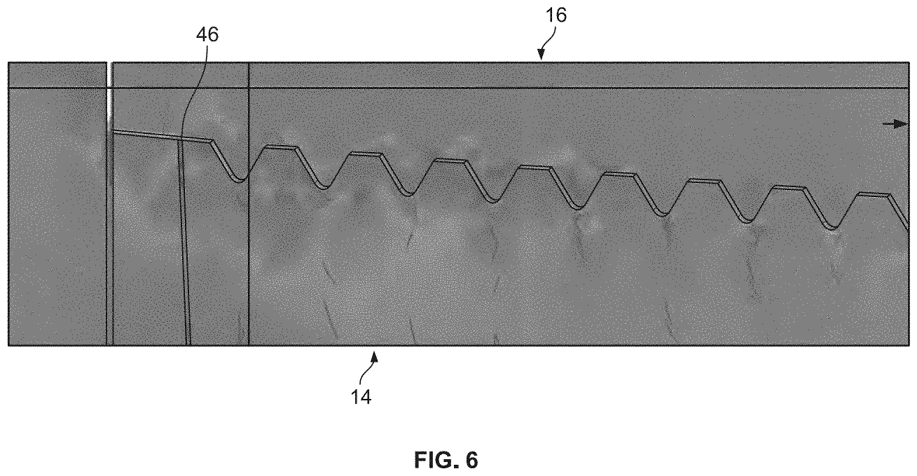

Referring back to FIG. 1, the pin thread 20 of the present invention has a base 30 of increased width wₚ when compared to the width w_{b} of the base 32 of the box thread 24. As can be seen in FIG. 5, the contact area 54 of the pin thread 20 to the pin body, shown in hatched lines, is increased by increasing the width wₚ of the pin thread base 30 compared to traditional thread designs. This provides a larger contact area over which the stress on the pin thread can be distributed and reduces the concentration of shear stress in the pin 14. As can be seen in FIG. 6, the stress concentration near the shoulder 46 of the pin 14 is greatly reduced compared to a traditional thread design. The stress does not extend as deeply into the body 18 of the pin 14 and the stress in the pin 14 is similar to the stress distribution pattern in the box 18 when compared to traditional threads. This results in a greater fatigue resistance and a reduced frequency of pin thread shearing.

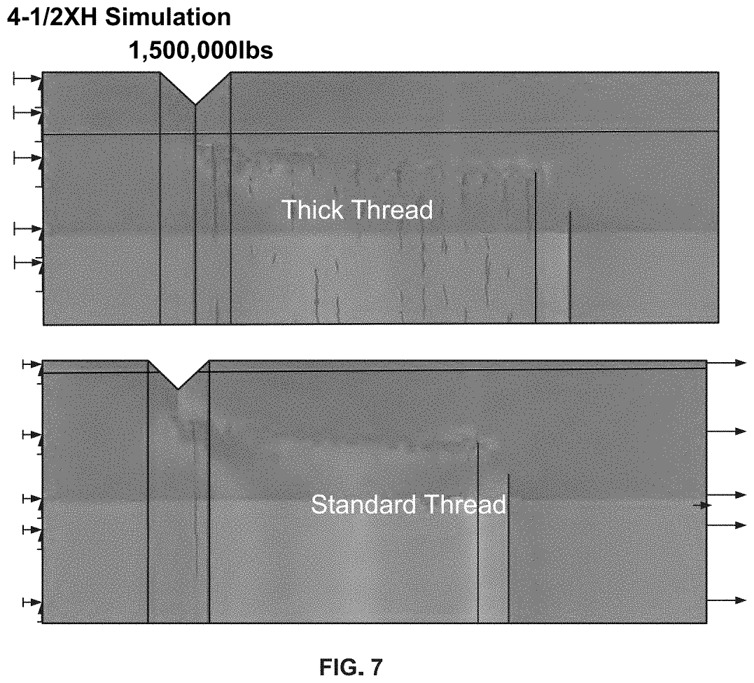

In a preferred embodiment, the base 30 of the pin thread 20 is increased such that the contact area 54 of the pin base 30 to the pin body 18 is generally the same as the contact area 56 of the box base 32 to the box body 22. This results in a more even disruption of stress between the pin and box threads. FIG. 7 shows a simulation comparing a standard pin thread to a pin thread having an increased base width wₚ. As can be seen from the figures, the stress concentration, especially near the shoulder of the pin and throughout the interior of the pin is greatly reduced when compared to the same simulation performed on the standard thread.

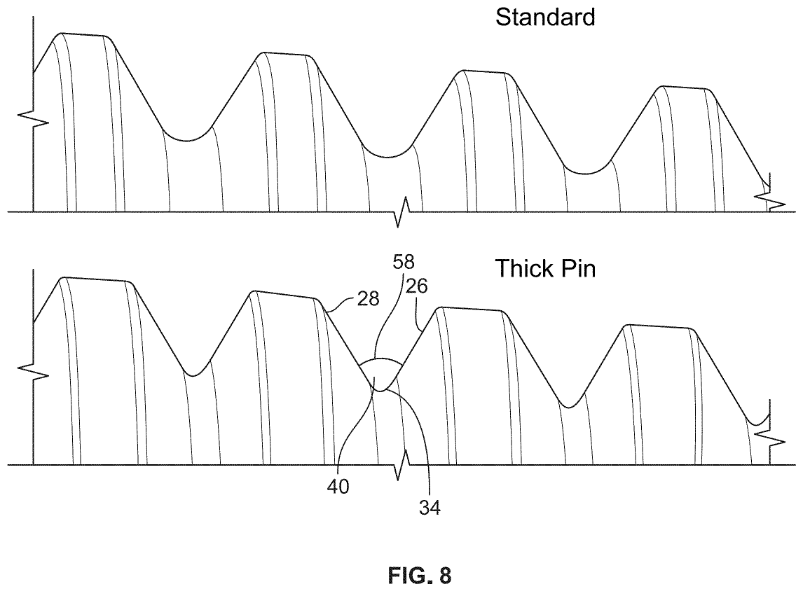

The widening of the pin base can optionally be paired with other changes in thread design. As seen in FIG. 8, by widening the pin thread base 30 and maintaining the angle 58 between the leading flank 26 and trailing flanks 28, a smaller root 34 between adjacent threads results. This means that the crest 40 of the box thread has a smaller radius than a standard box thread design. Although the preferred embodiment shown in the prior art has a generally symmetrical design about the root of the pin thread, it can be appreciated by a person skilled in the art that the geometry of the thread could be varied while maintaining a pin thread base that is wider than the box thread base.

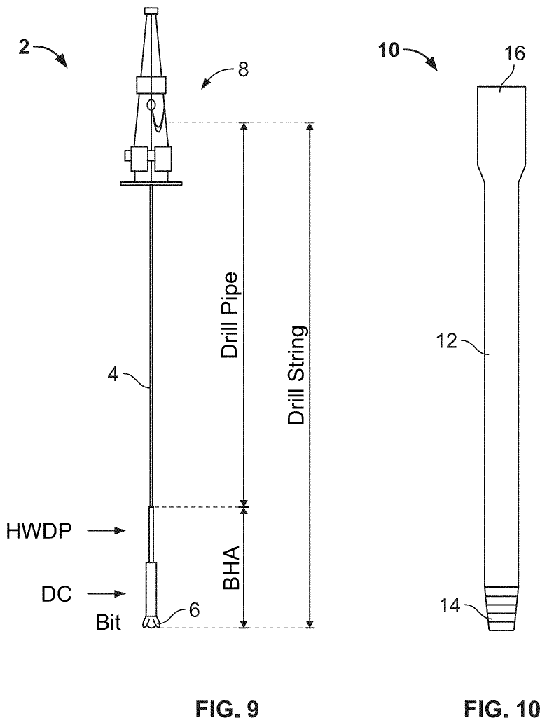

An example of an industrial application of the threaded connection described above is in the oil industry. FIG. 9 shows a drilling apparatus 2 for use in drilling into or across the ground for the purposes of oil excavation, well drilling or the like. The drilling apparatus 2 has a drill string 4. The drill string is attached, at one end, to a drill bit 6, and at a second end, to the rig 8 which has a drive mechanism configured to rotate the drill bit to facilitate drilling into the ground. The drill string 4 is tubular in design and acts as a conduit to allow for the removal of mud, earth or rock from the wellbore as well as to provide a passage for the circulation of drilling fluid.

As the wellbore becomes deeper, there is a need for a longer drill string 4 to allow the bit 6 to progress deeper into the ground. Thus, drill strings are designed to be comprised of a series of tubulars aligned longitudinally and connected by a tool joint connection, typically a threaded connection. As the need for a longer drill string arises, a portion of the drill string 4 is disconnected and another tubular is added to the drill string, thus providing additional length.

FIG. 10 shows a tubular 10 having an elongate body portion 12, a pin end 14 and a box end 16. Although this tubular is shown as having a pin end and a box end, it can be appreciated that a tubular could have two pin ends, or two box ends as long as the tool joint between two adjacent tubulars in the drill string consists of a pin end and a box end. In a preferred embodiment, the elongate body portion is 30-40 ft in length. It can also be appreciated that the tool joint connection described below could be applied to a collar used to connect two adjacent tubulars where the collar provides two box ends and the tubulars have two pin ends.

Although the specific examples shown in the figures related to a tool joint connection between adjacent tubulars in a drill string, it can be appreciated by a person skilled in the art that the same principles could be applied to any tool joint connection, for example drill collars and casings.

Although the invention has been described with reference to certain specific embodiments, various modifications thereof will be apparent to those skilled in the art without departing from the spirit and scope of the invention as outlined in the claims appended hereto. The entire disclosures of all references recited above are incorporated herein by reference.

1. A threaded connection comprising;
a pin having a body and a helically extending external pin thread;
a box having a body and a helically extending internal box thread;
wherein the external pin thread and internal box thread are configured for connection with each other such that when connected the pin body and the box body are aligned longitudinally;
said box thread having a box base in contact with the box body and said pin thread having a pin base in contact with said pin body; and
wherein said pin base is wider than said box base.

2. A threaded connection as claimed in claim 1 wherein the area wherein the box base is in contact with the box body defines the box contact area and the area wherein the pin base is in contact with the pin body defines the pin contact area and wherein said pin contact area and said box contact area are the same.

3. A drill string tubular comprising;
an elongate hollow body having a first end and a second end;
a pin extending from said first end; and
a box extending from said second end;
said pin having a body and a helically extending external pin thread;
said box having a body and a helically extending internal box thread;
and the external pin thread of a first tubular is configured for connection to an internal box thread of a second tubular such that when connected the first tubular and the second tubular are aligned longitudinally;
said box thread having a box base in contact with the box body and said pin thread having a pin base in contact with said pin body; and
wherein said pin base is wider than said box base.

4. A drill string tubular as claimed in claim 3 wherein the area wherein the box base is in contact with the box body defines the box contact area and the area wherein the pin base is in contact with the pin body defines the pin contact area and wherein said pin contact area and said box contact area are the same.
